(19) United States
(12) Patent Application Publication
(10) Pub. No.: US 2020/0149529 A1
(43) Pub. Date: May 14, 2020

(54) Foldable Handheld Pump

(71) Applicant: ACTIVE TOOLS INTERNATIONAL (HK) LTD., Causeway Bay (HK)

(72) Inventors: Koon Fung Lam, Causeway Bay (HK); Wai Kwong Ching, Causeway Bay (HK); Liuxi Xing, Causeway Bay (HK)

(21) Appl. No.: 16/617,131

(22) PCT Filed: May 26, 2017
(86) PCT No.: PCT/CN2017/086170

§ 371 Date: Nov. 26, 2019

(51) Int. Cl. F04C 3/04; F04C 29/12

(52) U.S. Cl. CPC F04C 3/04; B60C 23/10; F04C 29/124

(57) ABSTRACT

A hand-held inflation device comprising: a first housing (10) in which a motor (11) is mounted; a second housing (20) in which a compression means (21) for generating compressed air is mounted; the second housing (20) is rotatably mounted to the first housing (10) such that the second housing (20) is foldable relative to the first housing (10) between a folded position and an extended position; coupling means (22) for coupling the motor (11) to the compression means (21) in at least one position between the folded position and the extended position, such that the motor (10) is capable of driving the compression means (21).

### TECHNICAL FIELD

The present invention relates generally to a foldable hand-held inflation devices, such as a pump.

### BACKGROUND OF THE INVENTION

Inflation devices such as air pumps are common in the art and are used to provide compressed air to fill tires and the like. The pump comprises a power unit and a compression means. The power unit is powered to generate a rotary power output and then transmit it to the compression means, which compresses the compressed air. For example, the motor drives a pump crankshaft through two triangular belts to drive the piston to compress the gas and the compressed gas is introduced into the reservoir through a pipe. It is possible to set a pressure valve. When the pressure in the cylinder does not reach the pressure set by the pressure valve, the compressed gas accumulates in the gas cylinder, and the gas can not open the pressure valve. When the pressure inside the cylinder reaches the pressure valve, the gas from the cylinder opens the valve of the pressure valve and is discharged from an outlet into the article to be inflated.

However, such inflation devices are generally large in size and are only suitable for use in fixed plants and are not easy to carry.

Therefore, it is necessary to propose an inflation device which can be easily carried and foldable for easy accommodation. Such inflation devices may, for example, be placed in an automobile car to inflate a tire when it is needed.

### CONTENT OF THE INVENTION

The present application provides a hand-held inflation device comprising: a first housing in which a motor is mounted; a second housing in which a compression means for generating compressed air is mounted; the second housing is rotatably mounted to the first housing such that the second housing is foldable relative to the first housing between a folded position and an extended position; coupling means for coupling the motor to the compression means in at least one position in between the folded position and the extended position, such that the motor is capable of driving the compression means.

In one embodiment, the coupling means comprises: a first coupling means mounted in the first housing and driven by the motor, and a second coupling means in the second housing 20 which is capable of being coupled to the first coupling means, said second coupling means is coupled to the compression means.

In another embodiment, the first and second coupling means comprise a plain gear, a curved gear or a bevel gear.

In another embodiment, the coupling means transfers the output of the motor to the compression means in the folded position, such that the motor drives the compression means.

In another embodiment, the first housing is rotatably mounted to the second housing around an axis, the first housing is continuously rotatable relative to the second housing, or the first housing is step-rotated relative to the second housing.

In another embodiment, the coupling means is able to transfer the output of the motor to the compression means in each position in between the folded position and the extended position, such that the motor can drive the compression means.

In another embodiment, in the extended position, the first housing is substantially parallel to the second housing, and in the folded position, the first housing being substantially perpendicular to the second housing.

In another embodiment, further comprises a clutch means for selectively controlling the coupling of said first coupling means and said second coupling means.

In another embodiment, further comprises a biasing means which biases the first coupling means or the second coupling means for the engagement of the first and second coupling means, the activation of the clutch means will overcome a bias force of the biasing means such that the first coupling means disengaged from the second coupling means.

In another embodiment, further comprises locking means for selectively locking said first housing and said second housing.

In another embodiment, further comprises a clutch means for selectively controlling the coupling of said first coupling means and said second coupling means.

In another embodiment, the activation of the locking means simultaneously activates the clutch means to allow the relative rotation between the first housing and the second housing.

In another embodiment, the first coupling means comprises a pair of engaging bevel gears, a pair of intermeshing intermediate drive gears, the second coupling means comprising a bevel gear and a threaded bolt engaging thereto, the intermediate drive gear is selectively engageable with the threaded bolt so that the intermediate drive gear can rotate with the threaded bolt.

In another embodiment, further comprises locking means for selectively locking said first housing and said second housing.

In another embodiment, further comprises a clutch means for selectively controlling the coupling of intermediate drive gear and the threaded bolt.

In another embodiment, the activation of the locking means simultaneously activates the clutch means to allow the relative rotation between the first housing and the second housing.

### DESCRIPTION OF THE DRAWINGS

FIG. 1 shows an embodiment of the invention in which the first housing is generally perpendicular to the second housing.

FIG. 2 shows an embodiment in which the first housing and the second housing are substantially parallel to each other.

FIG. 3 shows an internal structure where the housings are omitted, the motor and the compression means are in a substantially parallel state.

FIG. 4 shows a state in which the motor and the compression means are rotated to an angle with respect to each other.

FIG. 5 shows a state in which the motor and the compression means are rotated with respect to each other to a substantially perpendicular state.

FIG. 6 shows another embodiment in which the coupling means is shown in more details.

FIG. 7 is another embodiment of the coupling device.

### DETAILED EMBODIMENTS

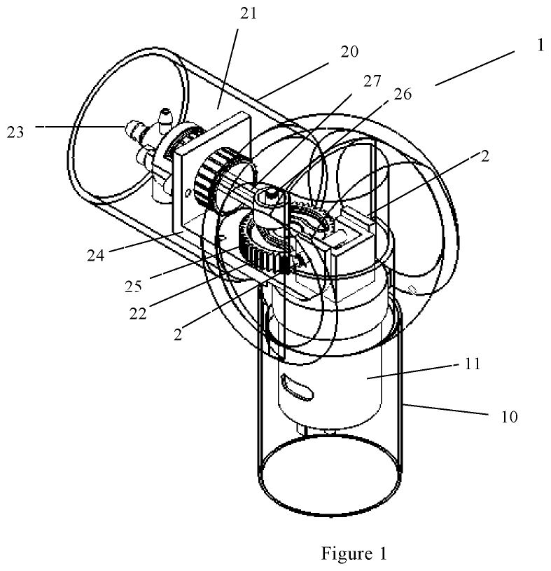

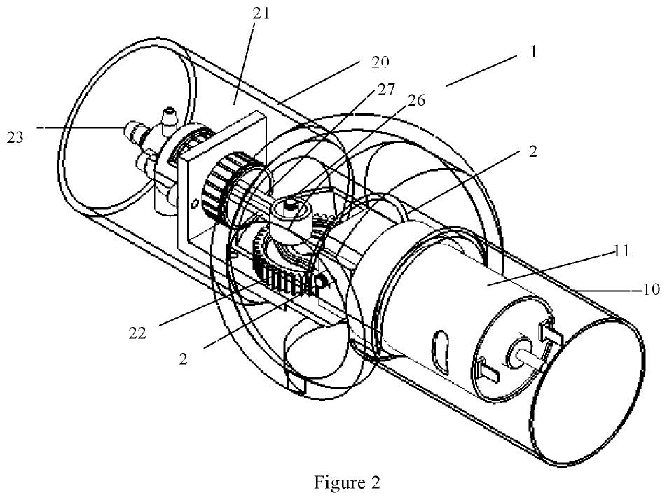

FIG. 1 and FIG. 2 show an embodiment of a hand-held inflation device of the present invention, FIG. 1 shows a folded position and FIG. 2 shows an extended position. The inflation device 1 includes a first housing 10 and a second housing 20. The first housing 10 and the second housing 10 are illustrated in a perspective manner to clearly show the structures therein. A power device such as a motor 11 is provided in the first housing 10. The motor 11 has an output shaft coupled to the first coupling means (which can be similar to the configuration as shown in FIG. 6) to drive the first coupling means to rotate. The motor 11 may be driven by an external power source (not shown). In an example, the external power source could be the power output of a car.

The second housing 20 is provided with a compression means 21 for providing compressed air. A second coupling means 22 is also provided, which is selectively coupled with the first coupling means so that the first coupling means can selectively drive the second coupling means 22. The second coupling means is also coupled to the compression means 21 so that the power output of the motor can be transmitted to the compression means 21 through the first coupling means and the second coupling means, thereby driving the compression means 21 to operate. The compression means 21 is provided with a discharge outlet 23 for discharging compressed air. It can be appreciated that the first coupling means can include a gear mounted on a driven shaft of the motor, which gear can be engaged with the gear 25 of the second coupling means at the position of FIG. 1. Thus, the motor can drive the compression means 21 to compress air. In one embodiment, the first coupling means and the second coupling means are disengaged when the first housing 10 and second housing 20 rotate with respect to each other from FIG. 1, then the motor can not drive the compression means 21. In another embodiment, the first coupling means and the second coupling means are engagable at each position in which the first housing and the second housing rotate with respect to each other.

For easy installation, the compression means 21 may be provided on a bracket 24, which is then secured to the second housing. One skilled in the art would understand that the bracket 24 can be eliminated if desired. The compression means 21 can be directly mounted on the inner surface of the second housing.

The compression means 21 may be a known piston compression means or a diaphragm compression means. For example, the piston compression means may include a cylinder, a piston, a crankshaft, or the like. The second coupling means can drive the crankshaft so that the piston is reciprocated to achieve gas compression. The diaphragm compression means may consist of a diaphragm, a crankshaft, a cylinder block, oil and gas lines, an electrical control system, and some accessories. Of course, the diaphragm compression means may also include a piston to drive the diaphragm.

The bracket 24 is an L-shaped support, including a vertical wall and a horizontal wall. The vertical wall includes a through hole therein. The cylinder of the compression means is installed through the through hole. An end of the cylinder is provided with the discharge outlet 23 for coupling with a hose.

FIG. 1 shows a state, i.e. folded position, in which the first housing 10 and the second housing 20 are substantially perpendicular to each other. The first housing 10 and the second housing 20 can be rotated relative to the imaginary axis 2 so as to rotate to the state of FIG. 2 in which the first housing 10 and the second housing 20 are substantially parallel, i.e. extended position. It will be appreciated that the angle between the first housing 10 and the second housing 20 may vary from 90 degrees to 180 degrees. As will be described below, in one embodiment, the first housing 10 and the second housing 20 may be steplessly rotated relative to each other, that is, the first housing 10 and the second housing 20 may stop at any angle between 90 degrees to 180 degrees, and the first housing 10 and the second housing 20 can be locked at the selected angle. In another embodiment, the first housing 10 and the second housing 20 may be step rotated, i.e. relatively rotated to one of several predetermined positions. For example, the angles of the first housing 10 and the second housing 20 may vary to 90 degrees, 120, 150 or 180 degrees.

Preferably, a locking device is provided to lock the first housing 10 and the second housing 20 for preventing relative rotation. When the first housing and the second housing are required to rotate relative to each other, the locking means is actuated to allow relative rotation between the first housing and the second housing. The first housing and the second housing will be re-locked when the first housing 10 and the second housing 20 are rotated to the desired position, and thus they can not rotate relative to each other. Optionally, the locking device can not be actuated when the motor 11 is actuated.

In one embodiment, the second coupling means 22 includes a gear 25, which may be a suitable type of gear, e.g. a spur gear, a bevel gear or a curved gear, for coupling with the first coupling means. The gear 25 is rotatably mounted about an axis. A driving pin 26 is provided eccentrically on the gear 25, and the driving pin 26 rotates with the gear 25. A piston rod 27 is connected to the drive pin 26, whereby the rotation of the gear 25 can be converted into the reciprocating motion of the piston rod 27. The piston rod 27 drives the piston (not shown) to reciprocate within the cylinder 28, thereby achieving air compression. It can be appreciated that the cylinder 28 is provided with an inlet valve and an outlet valve as known in the art. The gear 25 of the second coupling means is rotatably mounted on the horizontal wall of the bracket 24. In one embodiment, the conical gear 25 may also be configured to be movable in the longitudinal direction of the horizontal wall. A biasing means is provided to bias the bevel gear 25 to engage with the first coupling means. In case the biasing force of the biasing means is overcome, the bevel gear 25 can be moved in the longitudinal direction of the horizontal wall so as to be disengaged from the first coupling means.

Other devices may also be contemplated by those skilled in the art to effect the conversion of the rotation of the gear 25 into a reciprocating motion of the piston.

Optionally, a clutch device may be provided to selectively control the engagement of the first coupling means and the second coupling means. When the clutch device is activated, the first coupling means and the second coupling means can be disengaged when the first housing and the second housing are relatively rotated. And when the first housing and the second housing are rotated to the desired position, the clutch device is not activated and thus the first coupling means and the second coupling means are re-engaged.

The clutch can be controlled by the locking device. When the locking device is activated, the clutch will be activated so that the first coupling means and the second coupling means can be disengaged. When the locking device is not activated, the clutch will be de-activated so that the first coupling means and the second coupling means are re-engaged.

FIG. 2 shows that the first housing 10 and the second housing 20 are substantially parallel to each other. The user can select an appropriate configuration for storing the inflation device by rotating the first housing 10 and the second housing 20. The appropriate configuration can be the folded position of FIG. 1, or the extended position of FIG. 2, or any position between the folded position and the extended position. Thus, the inflation device provides a high flexibility for storage.

In one embodiment, a recovery means can be provided to assist the inflation device returning to the extended position as shown in FIG. 2. The recovery means can be a spring leaf. Therefore, when the inflation device is changed from the position of FIG. 2 to the position of FIG. 1, the user needs to overcome the flexibility of the spring leaf. The locking means locks the first housing 10 and the second housing 20 when they are in the substantially perpendicular position (FIG. 1). The inflation device then can be used for pumping air. After the use of the inflation device, the locaking means can be activated so that the inflation device will resume to the position of FIG. 2 by the recovery means.

Preferably, the extended position of the inflation device can be adjusted by a stop means. The stop means limits the angle between the first housing 10 and the second housing 20, for example 170 degrees. The user can use the stop means to adjust the angle limit between the first housing 10 and the second housing 20, thereby control the extended position of the inflation device.

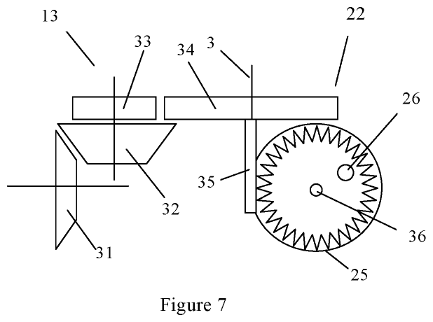

In another embodiment, the first coupling means and the second coupling means 22 remain engaged in the position of FIG. 2 so that the motor 11 can drive the compression means 21 to produce compressed gas. In this embodiment, the coupling means as shown in FIG. 7 can be used. One skilled in the art would also envisage other suitable coupling means with the teaching of the present application.

Therefore, with the present application, the user can choose an appropriate position (FIG. 1 or FIG. 2) for pumping the air or for storage. The intermediate position between FIG. 1 and FIG. 2 is also possible.

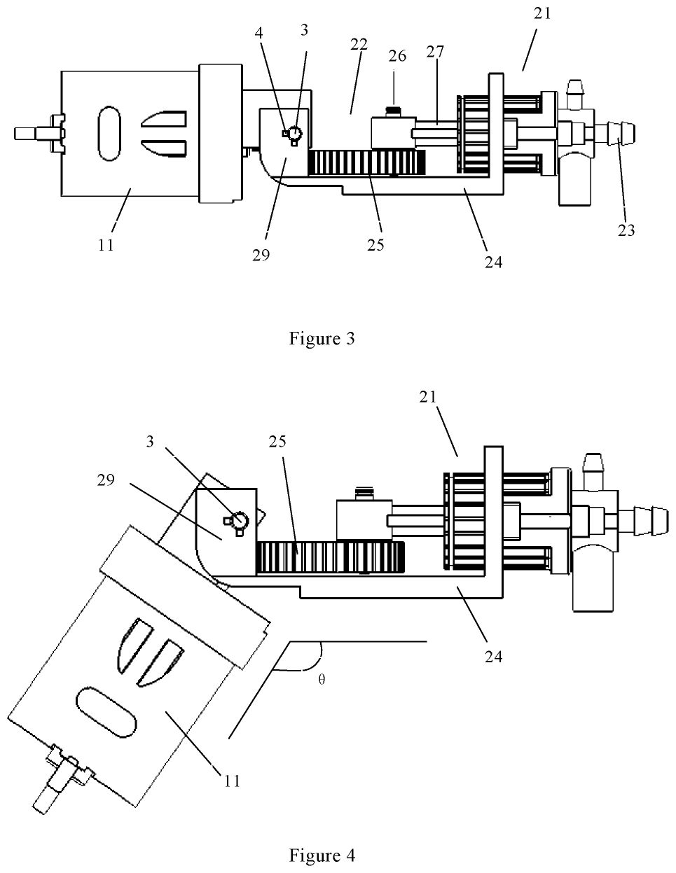

In order to more clearly show the internal structure, the first housing and the second housing are omitted in FIGS. 3-6. The embodiments of FIGS. 3-5 illustrate the use of a plain gear as second coupling means, and the embodiment of FIG. 6 shows the use of a bevel gear as a second coupling means.

FIG. 3 shows an embodiment in which the motor 11 and the compression means 21 are arranged substantially in parallel. The bracket 24 is provided with two support plates 29. The motor portion is coupled to the support plates 29 by means of a shaft 3 so that the motor 11 can be rotated about the shaft 3. The gear 25 is rotatably mounted on the bracket 24. The gear 25 may be a plain gear, or may be a bevel gear or a curved gear as long as the gear 25 is engageable with the first coupling means at a predetermined position. FIG. 3 shows the discharge outlet 23 of the compression means 21, which may be connected to an object to be inflated, such as a tire, by a hose (not shown). The driving pin 26 is eccentrically mounted on the gear 25. The gear 25 drives the driving pin 26 to rotate about the axis of the gear 25, and the piston rod 27 is connected to the drive pin 26, thereby causing the piston rod to move reciprocally. It will be appreciated that the drive pin 26 may be replaced with a crankshaft which may be coaxially mounted with the gear 25 and driven by the gear 25.

A clutch device may be provided to selectively control the engagement of the first coupling means and the second coupling means. For example, taking FIG. 3 as an example, the gear 25 of the second coupling device 22 may be mounted so as to be movable in the horizontal direction. A biasing means is provided to bias the gear to the left side for engagement with the first coupling means. In this way, the first coupling means and the second coupling means can be disengaged when the gear 25 is pushed to the right by overcoming the biasing means. In another embodiment, the biasing means can be provided on the first coupling means for biasing the gear of the first coupling means to engage with the gear 25 of the second coupling means.

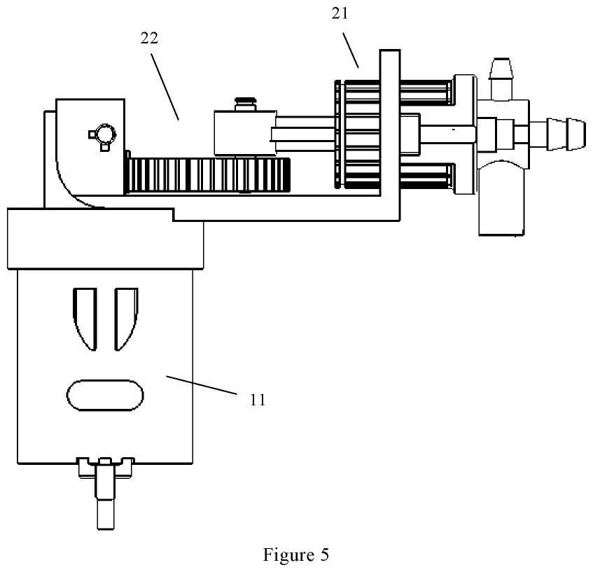

The motor 11 of FIG. 3 is rotated around the axis 3 relative to the compression means 21 to enter the position shown in FIG. 4, where the angle θ formed by the motor 11 and the compression means 21 is about 135 degrees. It is worth noting that the angle of 135 degrees is just an example. It will be appreciated by those skilled in the art that the motor 11 and the compression means 21 may be rotated to other angles within the range of 90-180 degrees.

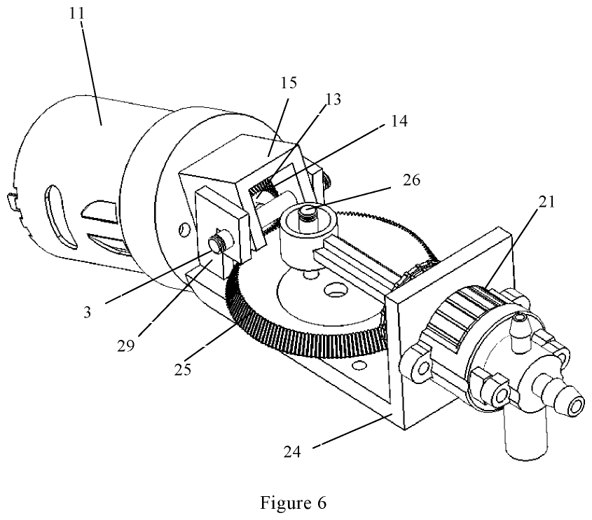

The motor 11 of FIG. 4 can continue to rotate relative to the compression means 21 to the position shown in FIG. 5 where the motor portion and the compression means portion are substantially perpendicular to each other. In this position, the first coupling means of the motor portion can be engaged with the gear 25 to transmit the output of the motor 11 to the compression means.

In another embodiment, the first coupling means and the second coupling means are also engageable at the positions shown in FIGS. 3 and 4, such that the motor 11 can still drive the compression means 21 to generate compressed air. In such embodiment, the coupling means as shown in FIG. 7 can be used. One skilled in the art would also envisage other suitable coupling means with the teaching of the present application.

It will be understood that the first housing 10 and the second housing 20 are also rotatable about the shaft 3 after the first housing 10 and the second housing 20 are mounted.

In one embodiment, the support plate 29 is provided with slots 4 corresponding to the predetermined angles between the first housing and the second housing. A spring-loaded pin (not shown) can be provided in the shaft 3. Thus, the pin will engage with one of the slots 4 when the first housing and the second housing rotates to a predetermined angle. In this connection, the first housing and the second housing can be rotated with respect to each other only when the pin is disengaged from the slots 4.

Due to the foldable design of the hand-held pump, the pump of the present invention can be applied to different applications and is more convenient for storage and use.

FIG. 6 shows an embodiment in which the gear 25 is a bevel gear. FIG. 6 also shows a first coupling means 13 comprising a bevel gear 14 which engages with the bevel gear 25. The motor 11 is mounted to the bracket 15, which is rotatably mounted to the support plate 29 about the shaft 3. The bracket 15 may be secured to the first housing. With this configuration, the first coupling means 13 cand the second coupling means 22 will be engaged when the first housing 10 and the second housing are in an angle of about 135 degrees.

It can be appreciated that, depending on the shape of the gears of the first and second coupling means, the first and second coupling means can be engaged at different angles. One skilled in the art would understand that curved gears can be used.

Although the first and second coupling devices are curved gears and/or bevel gears in some embodiments, those skilled in the art can also think of other coupling structures for power transmission.

For example, as shown in FIG. 7, the first coupling means 13 includes bevel gears 31 and 32, intermediate gears 33 and 34. The second coupling means 22 comprises a threaded bolt 35 with helically threaded or oblique threads and a bevel gear 25 engaged therewith. The bevel gear 25 is rotatable about the axis 36. The motor 11 drives the bevel gear 31, through the gears 32, 33, 34, and then drives the gear 25. The drive pin 26 is eccentrically mounted on the gear 25. A clutch device may be provided to selectively engage the gear 34 and the threaded bolt 35. The clutch device can be the friction clutch or electromagnet clutch known in the art. When the gear 34 and the threaded bolt 35 are engaged, the two are rotated together. When the gear 34 and the threaded bolt 35 are disengaged, the gear 34 will rotate independent of the threaded bolt 35. In this way, when the first housing and the second housing need to be rotated relative to each other, the clutch device is actuated so that the gear 34 and the rack 35 are disengaged, whereby the first housing and the second housing can be easily rotated. The coupling means of FIG. 7 allows the engagement of the first coupling means and the second coupling means at each position (angle), which provides more flexibility for the use of the inflation device.

The configuration as shown in FIG. 7 can be applied to the embodiments of FIGS. 1-6.

It is contemplated that the compression means 21 may also be provided with a gas reservoir, and the compressed air of the compression means first enters the gas reservoir and is then conveyed to the discharge outlet 23 through the gas reservoir. A pressure gauge is connected to the reservoir to indicate the pressure of the reservoir. A display device may be provided on the second housing 20 to show the pressure of the reservoir.

It is to be noted that although the invention has been described in detail in the specification, the foregoing detailed description should not be construed as limiting the invention but merely serves to explain the invention. The various features described above can be used in combination with each other without departing from the scope of the present invention.

1. A hand-held inflation device comprising:
a first housing in which a motor is mounted;
a second housing in which a compression means for generating compressed air is mounted;
the second housing is rotatably mounted to the first housing such that the second housing is foldable relative to the first housing between a folded position and an extended position;
coupling means for coupling the motor to the compression means in at least one position in between the folded position and the extended position, such that the motor is capable of driving the compression means.

2. A hand-held inflation device according to claim 1,
wherein the coupling means comprises:
a first coupling means mounted in the first housing and driven by the motor, and
a second coupling means in the second housing which is capable of being coupled to the first coupling means, said second coupling means is coupled to the compression means.

3. A hand-held inflation device according to claim 2, wherein the first and second coupling means comprise a plain gear, a curved gear or a bevel gear.

4. A hand-held inflation device according to claim 1, wherein the coupling means transfers the output of the motor to the compression means in the folded position, such that the motor drives the compression means.

5. hand-held inflation device according to claim 1, wherein the first housing is rotatably mounted to the second housing around an axis, the first housing is continuously rotatable relative to the second housing, or the first housing is step-rotated relative to the second housing.

6. A hand-held inflation device according to claim 1, wherein the coupling means is able to transfer the output of the motor to the compression means in each position in between the folded position and the extended position, such that the motor can drive the compression means.

7. A hand-held inflation device according to claim 1, wherein in the extended position, the first housing is substantially parallel to the second housing, and in the folded position, the first housing being substantially perpendicular to the second housing.

8. A hand-held inflation device according to claim 2, further comprises a clutch means for selectively controlling the coupling of said first coupling means and said second coupling means.

9. A hand-held inflation device according to claim 8, further comprises a biasing means which biases the first coupling means or the second coupling means for the engagement of the first and second coupling means, the activation of the clutch means will overcome a bias force of the biasing means such that the first coupling means disengaged from the second coupling means.

10. A hand-held inflation device according to claim 2, further comprises locking means for selectively locking said first housing and said second housing.

11. A hand-held inflation device according to claim 10, further comprises a clutch means for selectively controlling the coupling of said first coupling means and said second coupling means.

12. A hand-held inflation device according to claim 11, wherein the activation of the locking means simultaneously activates the clutch means to allow the relative rotation between the first housing and the second housing.

13. A hand-held inflation device according to claim 6, wherein:
the first coupling means comprises a pair of engaging bevel gears, a pair of intermeshing intermediate drive gears,
the second coupling means comprising a bevel gear and a threaded bolt engaging thereto,
the intermediate drive gear is selectively engageable with the threaded bolt so that the intermediate drive gear can rotate with the threaded bolt.

14. A hand-held inflation device according to claim 13, further comprises locking means for selectively locking said first housing and said second housing.

15. A hand-held inflation device according to claim 14, further comprises a clutch means for selectively controlling the coupling of intermediate drive gear and the threaded bolt.

16. A hand-held inflation device according to claim 15, wherein the activation of the locking means simultaneously activates the clutch means to allow the relative rotation between the first housing and the second housing.
